(19) United States
(12) Patent Application Publication
(10) Pub. No.: US 2008/0254681 A1
(43) Pub. Date: Oct. 16, 2008

(54) USB cable for use in industrial environments

(76) Inventor: Thomas B. O'Hanlan, Liberty, SC (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 12/079,810

(22) Filed: Mar. 28, 2008

Related U.S. Application Data
(60) Provisional application No. 60/920,414, filed on Mar. 28, 2007.

(51) Int. Cl. H01R 13/648

(52) U.S. Cl. 439/607

(57) ABSTRACT

The present invention is directed to an electronic data transfer cable comprising (a) a first end; (b) a second end; (c) a plurality of data transmission wires running the length of the data transmission cable; (d) an insulating sheath disposed at one of said data transfer cable first or second ends having a first end, a second end opposite the first end and connected to either of the data transfer cable first or second ends, at least one side surface extending between said insulating sheath first and second ends, and a tab extending outwardly from the sheath side surface and defining a through-hole; (e) a connector which slidably engages the through-hole; and (f) a plug extending outwardly from the sheath first end, the plug having a plurality of data transfer pins whereat said plurality of data transmission wires terminate.

### CROSS-REFERENCE TO RELATED PATENTS AND PATENT APPLICATIONS

This application is a non-provisional application and claims the priority benefit of U.S. Provisional Patent Application Ser. No. 60/920,414, filed Mar. 28, 2007, which is incorporated by reference herein in its entirety.

### FIELD OF THE INVENTION

The present invention relates generally to the field of cables for transferring data to and from a computer, and in particular to a robust universal serial bus cable that reduces the likelihood of inadvertent disconnection.

### BACKGROUND OF THE INVENTION

In the modern technological world, businesses and individuals rely heavily upon computer workstations to perform data processing functions. Frequently it is necessary to transfer data between a computer and a peripheral device such as a printer, external hard drive, or another computer. One common way of transferring data between a computer and a peripheral device is to connect one end of a data transfer cable to an input/output jack on the computer and then connect the other end of the cable to an input/output jack on the peripheral device. The types of input/output jacks have evolved to keep pace with the ever-changing computer industry, and today there are many varieties of jacks that require a cable equipped with an appropriate mating connector.

Currently, many computers and peripheral devices are equipped with at least one universal serial bus (USB) interface. The USB interface was originally designed to give home computer users an easy method to connect peripheral equipment to their computers. USB connectors are small, easy to align with their corresponding jacks, and can be connected and disconnected much faster than prior interfaces. These advantages have helped the USB interface rapidly become a preferred interface for both personal computers and office computers.

### SUMMARY OF THE INVENTION

The present invention recognizes and addresses considerations of prior art constructions and methods. The present invention is directed to an electronic data transfer cable comprising (a) a first end; (b) a second end; (c) a plurality of data transmission wires running a length of the data transmission cable; (d) an insulating sheath disposed at one of said data transfer cable first or second ends, having a first end, a second end opposite the first end and connected to either of the data transfer cable first or second ends, at least one side surface extending between said insulating sheath first and second ends, and a tab extending outwardly from the sheath side surface and defining a through-hole; (e) a connector which slidably engages the through-hole; and (f) a plug extending outwardly from the sheath first end, the plug having a plurality of data transfer pins whereat said plurality of data transmission wires terminate.

The present invention is additionally directed to an electronic data transfer cable comprising (a) a first end; (b) a second end; (c) a plurality of data transmission wires running a length of the data transmission cable; (d) an insulating sheath disposed at both of said data transfer cable first and second ends, each insulating sheath having, a first end, a second end opposite the first end and connected to either of the data transfer cable first or second ends, at least one side surface extending between said insulating sheath first and second ends, and a tab extending outwardly from the sheath side surface and defining a through-hole; (e) a connector for each insulating sheath, which slidably engages the through-hole; and (f) a plug extending outwardly from each of the insulating sheaths first end, the plug having a plurality of data transfer pins whereat said plurality of data transmission wires terminate.

The present invention is further directed to an electronic data transfer system comprising an electronic data transfer cable which contains, (a) a first end; (b) a second end; (c) a plurality of data transmission wires running a length of the data transmission cable; (d) an insulating sheath disposed at one of said data transfer cable first or second ends having a first end, a second end opposite the first end and connected to either of the data transfer cable first or second ends, at least one side surface extending between said insulating sheath first and second ends, and a tab extending outwardly from the sheath side surface and defining a through-hole; (e) a connector which slidably engages the through-hole; and (f) a plug extending outwardly from the sheath first end, the plug having a plurality of data transfer pins whereat said plurality of data transmission wires terminate. The electronic data transfer system further contains an electronic data receiving component. The electronic receiving component contains a jack with a plug receiving recess containing a plurality of data transfer pins. The plug data transfer pins align with the jack data transfer pins and the connector is releasably attached to the electronic data receiving component when the electronic data transfer cable is in engagement with the electronic data receiving component.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1A is a perspective view of a universal serial bus connector in accordance with an embodiment of the present invention;

FIG. 1B is a perspective view of a universal serial bus connector in accordance with an embodiment of the present invention;

FIG. 2A is a partial front view of an automated device having a universal serial bus jack in accordance with an embodiment of the present invention suitable for receiving a universal serial bus connector illustrated in FIG. 1A;

FIG. 2B is a partial front view of an automated device having a universal serial bus jack in accordance with an embodiment of the present invention suitable for receiving a universal serial bus connector illustrated in FIG. 1B;

FIG. 3A is a perspective view of the engagement between the universal serial bus connector illustrated in FIG. 1A and the universal serial bus jack illustrated in FIG. 2A;

FIG. 3B is a perspective view of the engagement between the universal serial bus connector illustrated in FIG. 1B and the universal serial bus jack illustrated in FIG. 2B;

FIG. 4A is a section view of a universal serial bus connector in accordance with an embodiment of the present invention; and

FIG. 4B is a partial perspective view of a universal serial bus connector in accordance with an embodiment of the present invention.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

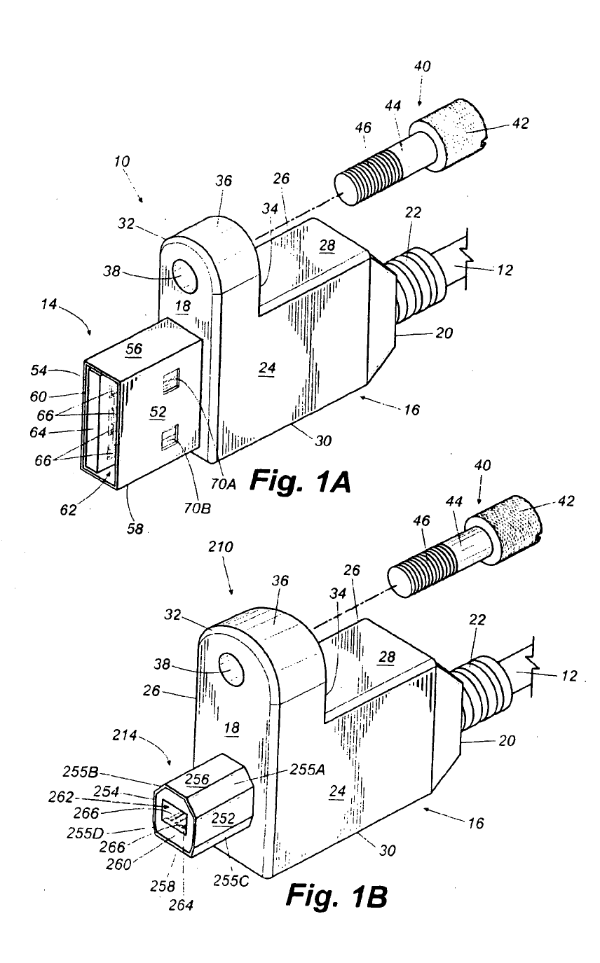

FIG. 1A shows one embodiment of a data transmission cable 12 having a rugged USB connector 10 in accordance with the present invention. Connector 10 is located at an end of cable 12 and has an interfacing plug 14, and an insulating sheath 16 that surrounds and protects the wires (not shown), which transmit electronic data. It should be understood that both ends of cable 12 may be equipped with a USB connector 10, but cable 12 may also have a USB connector at one end and an alternative connector at another end, such as a USB mini, parallel, or serial connector.

Insulating sheath 16 preferably has a first end surface 18 from which interfacing plug 14 extends, and a second end surface 20 from which data transmission cable 12 extends. Preferably, a strain relief 22 extends from sheath second end 20 and encircles cable 12, thus preventing the cable from fraying or kinking during use. Insulating sheath 16 also has a first side surface 24, a second side surface 26, a top surface 28, and a bottom surface 30. While sheath 16 preferably has a generally rectangular cross section, it should be understood that sheath 16 may have a cross section with any suitable shape, such as, for example, square, circular, triangular, hexagonal or oval-shaped.

In one embodiment, a tab 32 extends outwardly from insulating sheath top surface 28, and has a rear surface 34 that is generally perpendicular to sheath top surface 28. Tab 32 is positioned proximate to interfacing plug 14 such that insulating sheath first end surface 18 also forms the tab's forward facing surface while sheath first and second side surfaces 24, 26 form the tab's side surfaces. In this embodiment, tab 32 has a rounded top surface 36 that forms a smooth transition between sheath first and second side surfaces 24, 26. It should be understood that tab top surface 36 may have any suitable profile, such as flat or beveled, for example. A through-hole 38 is formed in tab 32 and is positioned proximate to top surface 36. Through-hole 38 is sized appropriately to receive a thumb screw 40 having a head 42 and a threaded shaft 44 that defines screw threads 46. Insulating sheath through-hole 38 slidably receives thumb screw threaded shaft 44 such that screw threads 46 extend outward from insulating sheath first end 18.

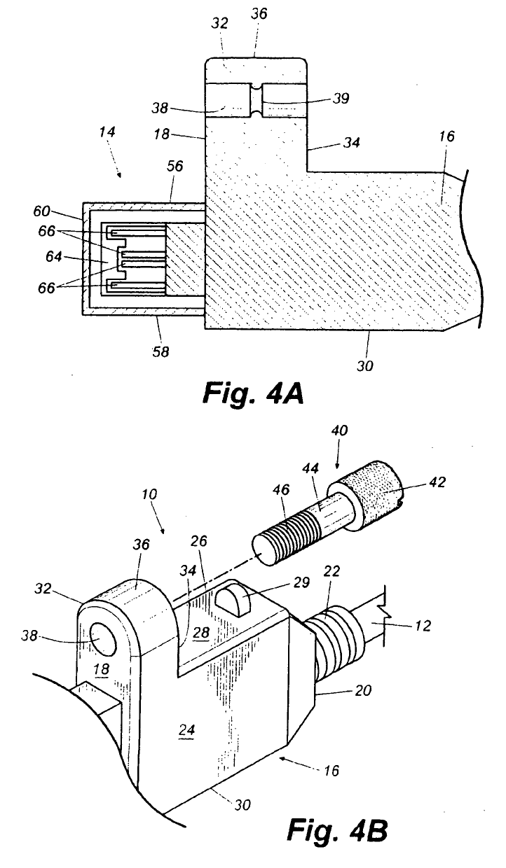

Although FIG. 1A illustrates tab 32 extending outwardly from insulating sheath top surface 28, it should be understood that tab 32 may also extend from first or second side surfaces 24, 26, or from bottom surface 30. Tab 32 may also provide a stop mechanism that prevents thumb screw 40 from sliding out of through-hole 38. For example, through-hole 38 may define a circumferential rib 39 about its interior surface at a point intermediate tab rear surface 34 and insulating sheath first end surface 18 as shown in FIG. 4A. During assembly of connector 10, as thumb screw 40 is inserted into through-hole 38, screw threads 46 will engage the circumferential rib 39. Because the screw threads are not smooth, additional force will be required to push the screw threads past the rib. The rib will preferably deform slightly to allow the screw threads to pass. Preferably, in addition to having electrical insulating properties, insulating sheath will also have some flexible resiliency, and, accordingly, the circumferential rib will also be flexibly resilient. Once the rib deforms to allow the screw threads to pass, the rib will return to its original form, allowing the thumb screw to slide within the through-hole. However, any engagement between the screw threads and the rib will prevent the screw from simply sliding out of the through-hole. Instead, the user will have to exert additional pulling force upon the screw head to cause the screw threads to engage and deform the flexible rib sufficiently for the screw threads to pass over the rib, thus allowing the user to remove the screw from the through-hole.

Other means of slidably retaining thumb screw 40 in through-hole 38 may also be employed, such as, for example, a flexible stopping-tab 29 shown in FIG. 4B. Stopping tab 29 is preferably formed on insulating sheath top surface 28 and engages screw head 42. During assembly, as thumb screw 40 is inserted into through-hole 38, screw head 42 will engage stopping tab 29, and additional force will be required to push the screw head past the tab. Because of the flexible resiliency of the material from which insulating sheath is preferably formed, stopping tab 29 will deform slightly to allow the screw head to pass. Once the screw head passes over the stopping tab, the tab will return to its original form, allowing the thumb screw to slide within the through-hole. However, any engagement between the screw head and the rib will prevent the screw from simply sliding out of the through-hole. Instead, the user will have to exert additional pulling force upon the screw head to cause the screw head to engage and deform the flexible stopping tab sufficiently for the screw head to pass over the rib, thus allowing the user to remove the screw from the through-hole.

While element 40 is described as a “thumb screw”, it should be understood that element 40 could be any type of screw that will engage the connector 10 to the electronic component 300. For example, element 40 can be a slotted screw, a Phillips screw, a hex cap screw, or any other screw that would serve the invented purpose.

Interfacing plug 14 is shown as a standard USB A Series plug, as identified by its elongated rectangular shape. Plug 14 has a first sidewall 52, a second sidewall 54, a top wall 56, and a bottom wall 58, all of which terminate in a jack engaging end 60. Jack engaging end 60 defines a pin connection recess 62, inside of which is located a generally flat pin board 64 equipped with four data transfer pins 66. Data transfer pins 66 represent the terminus of a plurality of data transmission wires (not shown), such as commonly known twisted pairs of copper wire or similar wires. The data transmission wires pass through the interior of insulating sheath 16 and cable 12 and terminate at a connector at another end of the data transmission cable, thus allowing electronic data to be communicated between a computer and a peripheral device via the data transmission cable. Pin board 64 is positioned proximate to the interior surface of sidewall 54 such that data transfer pins 66 face the interior surface of sidewall 52. Additionally, plug sidewall 52 defines two generally square alignment recesses 70A and 70B. Similar recesses may also be formed in plug sidewall 54.

Turning now to FIG. 1B, an alternative embodiment of rugged USB connector 210 in accordance is shown. Connector 210 is largely the same as connector 10 (FIG. 1A), but is instead equipped with an interfacing plug 214 that is shown as a standard USB B Series plug, as identified by its generally square shape with chamfered corners. Interfacing plug 214 has a first sidewall 252, a second sidewall 254, a top wall 256, and a bottom wall 258, all of which terminate in a jack engaging end 260. First sidewall 252 and top wall 256 are connected by a flat chamfer 255A, while second sidewall 254 and top wall 256 are connected by a flat chamfer 255B. Similarly, first sidewall 252 and bottom wall 258 are connected by a flat chamfer 255C, while second sidewall 254 and bottom wall 258 are connected by flat chamfer 255D. Jack engaging end 260 defines a generally square pin connection recess 262, having a bottom surface 264 equipped with two data transfer pins 266. The top surface (not shown) of pin connection recess 262 is also equipped with two data transfer pins (not shown). It should be understood that a USB Mini-A or USB Mini-B series plug, HDMI plug, FIREWIRE plug, or other similar plug having quick-connect/disconnect functionality may be substituted for the USB A and USB B series plugs described herein.

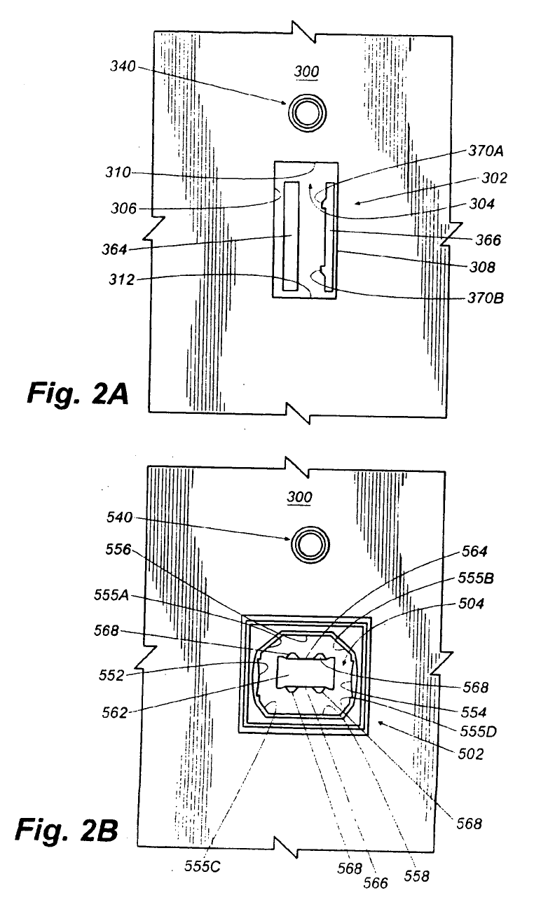

Tuning now to FIG. 2A, an electronic component 300 is shown equipped with a USB A Series jack 302 suited for receiving the interfacing plug 14 of USB connector 10 (FIG. 1A). Jack 302 has a plug receiving recess 304, having a first sidewall 306, a second sidewall 308, a top wall 310, and a bottom wall 312. A generally flat pin board 364 having four data transfer pins (not shown) is positioned inside plug receiving recess 304 proximate to sidewall 306 such that the data transfer pins of pin board 364 engage USB connector pins 66 (FIG. 1A) when interfacing plug 14 is inserted into USB jack. Plug receiving recess 304 may also be equipped with a flexible retaining tab 366 having two ears 370A and 370B that releasably engage interfacing plug alignment recesses 70A and 70B as described in further detail below. Electronic component 300 also has a threaded bore 340 located directly above jack 302 and sized appropriately to receive connector thumb screw threads 46 (FIG. 1A) as described below.

Referring to FIG. 2B, an electronic component 300 is equipped with a USB B Series jack 502 suited for receiving the interfacing plug 214 of USB connector 210 (FIG. 1B). Jack 502 has a plug receiving recess 504, having a first sidewall 552, a second sidewall 554, a top wall 556, and a bottom wall 558. First sidewall 552 and top wall 556 are connected by a flat chamfer 555A, while second sidewall 554 and top wall 556 are connected by a flat chamfer 555B. Similarly, first sidewall 552 and bottom wall 558 are connected by a flat chamfer 555C, while second sidewall 554 and bottom wall 558 are connected by flat chamfer 555D. A generally square pin board 562 has a top surface 564 and a bottom surface 566. Two data transfer pins 568 are located on each of pin board top surface 564 and pin board bottom surface 566 and are configured to engage with the corresponding data transfer pins 266 of interfacing plug 214 (FIG. 1B). Electronic component 300 also has a threaded bore 540 located directly above jack 502 and sized appropriately to receive connector thumb screw threads 46 (FIG. 1B) as described below.

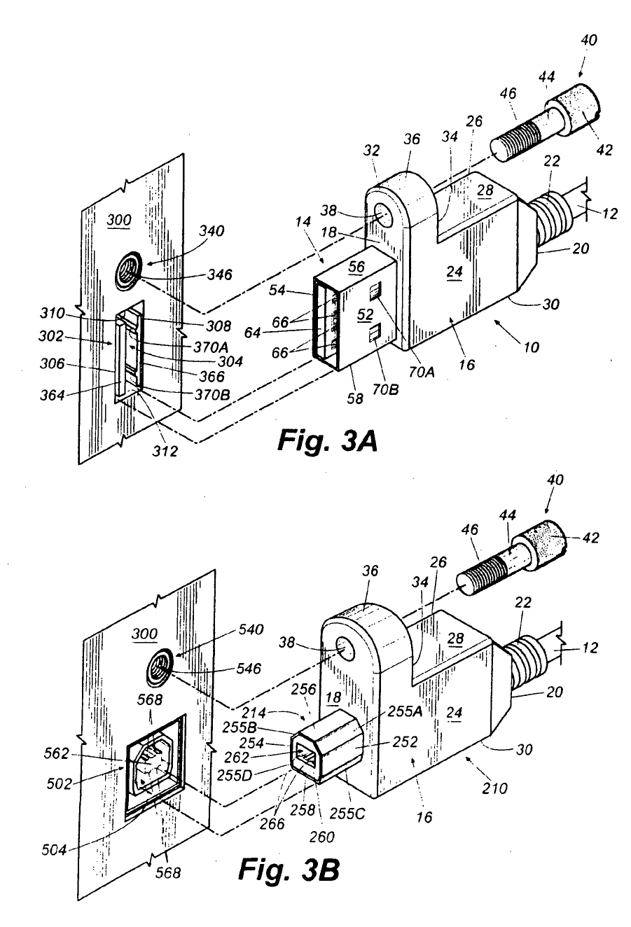

With reference now to FIG. 3A, a user may connect USB A Series connector 10 with USB jack 302 by sliding interfacing plug 14 into plug receiving recess 304. Plug first and second sidewalls 52, 54 slide against recess sidewalls 306, 308, respectively while plug top and bottom walls 56, 58 slide against recess top and bottom walls 310, 312, respectively. Simultaneously, plug pin board 64 engages recess pin board 364, allowing plug pins 66 to engage the pins (not shown) on recess pin board 364 and facilitating the transfer of electronic data.

As plug 14 enters into plug recess 304, flexible retaining tab 366 flexes outward toward recess second sidewall 308. When plug 14 is fully inserted into recess 304, the ears 370A, 370B of retaining tab 366 engage plug alignment recesses 70A, 70B, respectively, and flexible retaining tab 366 returns to its normal un-flexed state. The engagement between the retaining tab ears and the plug alignment recesses helps to ensure proper alignment between interfacing plug 14 and plug recess 304. Additionally, the engagement between the retaining tab ears and the plug alignment recesses ensures that the interfacing plug will not simply slide out of the plug recess when the engagement between connector 10 and jack 302 is left unattended.

When interfacing plug 14 is fully inserted into jack recess 304, connector insulating sheath first end 18 engages or is brought into close proximity with the external surface of electronic component 300. Additionally, through-hole 38 formed in insulating sheath tab 32 aligns with threaded bore 340. The user may then slide thumb screw 40 through the hole 38 until screw threads 46 engage the female threads 346 formed on the interior surface of threaded bore 340. The user may tighten thumb screw 40 by turning screw head 42. When thumb screw 40 is fully tightened, the engagement between screw threads 46 and threaded bore threads 346 ensures that USB connector 10 will not slide out of or disengage USB jack 302 unless the user fully unscrews thumb screw 40 from threaded bore 340. This secured engagement between connector 10 and jack 302 ensures the integrity of the engagement between the plug data transfer pins and the jack data transfer pins, and the transfer of electronic data from USB connector 10 to USB jack 302 will not be inadvertently interrupted.

If the user desires to disengage the USB connector and jack, she may simply unscrew thumb screw 40 from threaded bore 340. Once thumb screw 40 is fully unscrewed and disengaged from threaded bore 340, the user may then simply pull the USB connector plug out of the USB jack. The reward motion of connector 10 will cause the edge of plug alignment recesses 70A, 70B to engage retaining tab ears 370A, 370B, respectively. Retaining tab 366 will flex toward jack sidewall 308, allowing plug 14 to slide out of plug recess 304, thereby breaking the connection between the plug data transfer pins from the jack data transfer pins. It should be understood that retaining tab 366 may be replaced with two separate tabs, each for engaging one of plug alignment recesses 70A, 70B, or the retaining tab may be omitted all together.

Referring to FIG. 3B, a user may connect USB B Series connector 210 with USB jack 502 in a manner similar to that described above by sliding interfacing plug 214 into plug receiving recess 304. Plug first and second sidewalls 252, 254 slide against recess sidewalls 552, 554, respectively while plug top and bottom walls 256, 258 slide against recess top and bottom walls 556, 558, respectively. Plug chamfers 255A-D similarly slide against recess chamfers 555A-D, respectively. Simultaneously, jack pin board 562 engages recess plug square pin connection recess 262, allowing jack data transfer pins 568 to engage plug data transfer pins 266 pins and facilitating the transfer of electronic data.

As with connector 10 described above, through-hole 38 formed in insulating sheath tab 32 aligns with threaded bore 540 when connector 210 is properly inserted into jack 502. The user may then slide thumb screw 40 through the hole 38 until screw threads 46 engage the female threads 546 formed on the interior surface of threaded bore 540. By turning screw head 42, the user may tighten thumb screw 40 into bore 540. Once fully tightened, the engagement between screw threads 44 and threaded bore threads 546 ensures that USB connector 10 will not disengage USB jack 502 unless the user fully unscrews thumb screw 40 from threaded bore 540. The engagement between connector 210 and jack 502 ensures the integrity of the engagement between the plug data transfer pins and the jack data transfer pins, and the transfer of electronic data from USB connector 210 to USB jack 502 will not be interrupted.

If the user desires to disengage the USB connector and jack, he may simply unscrew thumb screw 40 from threaded bore 340. Once thumb screw 40 is fully unscrewed and disengaged from threaded bore 340, the user may then simply pull the USB connector plug out of the USB jack, thereby breaking the connection between the plug data transfer pins from the jack data transfer pins.

It should be understood that the thumb screw helps to provide a secure connection between the USB connector and an electrical component. However, the USB cable of the present invention may also be used with standard USB jacks that are not equipped with a threaded bore of the type described above. When used with a standard USB jack, the user simply may pull on the head of the thumb screw, sliding the screw backward in its through-hole so that the threaded end of the screw does not interfere with the connection between the USB plug and the USB jack. Similarly, a standard USB connector may be used to connect a USB cable to a USB jack having a threaded bore. In this instance, the USB connector will not be locked in place. The connection will not be as secure as when using the USB cable of the present invention, but the transfer of data will not be impaired unless a vibration, shock, or impact causes the USB connector to disengage the USB jack.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of the various embodiments may be interchanged either in whole or in part. For example, while methods for the production of a commercially sterile liquid nutritional supplement made according to those methods have been exemplified, other uses are contemplated. Therefore, the spirit and scope of the appended claims should not be limited to the description of the preferred versions contained therein.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

What is claimed is:

1. An electronic data transfer cable comprising
a. a first end;
b. a second end;
c. a plurality of data transmission wires running a length of said data transfer cable;
d. an insulating sheath disposed at one of said data transfer cable first or second ends, said insulating sheath surrounding said data transmission wires and having,
i. a first end,
ii. a second end opposite said sheath first end and connected to either of said data transfer cable first or second ends,
iii. at least one side surface extending between said insulating sheath first and second ends, and
iv. a tab extending outwardly from said insulating sheath side surface, said tab defining a through-hole;
e. a connector, said connector device slidably engaging said insulating sheath tab through-hole; and
f. a plug extending outwardly from said insulating sheath first end, said plug further comprising a plurality of data transfer pins where at said plurality of data transmission wires terminate.

2. The electronic data transfer cable of claim 1, wherein the plug is a Universal Series Bus A plug.

3. The electronic data transfer cable of claim 1, wherein the plug is a Universal Series Bus B plug.

4. The electronic data transfer cable of claim 1, wherein the tab of the insulating sheath is positioned above said plug.

5. The electronic data transfer cable of claim 1, wherein said insulating sheath further comprises a flexible stopping-tab located on said side surface intermediate said tab and said through-hole.

6. The electronic data transfer cable of claim 1, wherein said connector is a threaded thumb screw comprising a head, a shaft, and a plurality of screw threads formed on said shaft.

7. The electronic data transfer cable of claim 6, wherein said insulating sheath tab through-hole further comprises a circumferential rib located within said through-hole.

8. An electronic data transfer cable comprising
a. a first end;
b. a second end;
c. a plurality of data transmission wires running a length of said data transfer cable;
d. an insulating sheath disposed at both of said data transfer cable first end and second end, each of said insulating sheaths surrounding said data transmission wires and having,
i. a first end,
ii. a second end opposite said sheath first end and connected to either of said data transfer cable first or second ends,
iii. at least one side surface extending between said insulating sheath first and second ends, and
iv. a tab extending outwardly from said insulating sheath side surface, said tab defining a through-hole;
e. a connector for each of said insulating sheaths, said connector slidably engaging said insulating sheath tab through-hole; and
f. a plug extending outwardly from each of said insulating sheath first ends, said plug further comprising a plurality of data transfer pins where at said plurality of data transmission wires terminate.

9. The electronic data transfer cable of claim 8, wherein the plugs are selected from the group consisting of Universal Serial Bus A plugs, Universal Serial Bus B plugs, and combinations thereof.

10. The electronic data transfer cable of claim 8, wherein at least one tab of either insulating sheath is positioned above the plug.

11. The electronic data transfer cable of claim 8, wherein at least one of said insulating sheaths further comprises a flexible stopping-tab located on said side surface intermediate said tab and said through-hole.

12. The electronic data transfer cable of claim 8, wherein at least one of said connectors is a threaded thumb screw comprising a head, a shaft, and a plurality of screw threads formed on said shaft.

13. The electronic data transfer cable of claim 12, wherein a least one of said insulating sheath tab through-holes further comprises a circumferential rib located within said through-hole.

14. An electronic data transfer system comprising
a. an electronic data transfer cable comprising:
i. a first end;
ii. a second end;
iii. a plurality of data transmission wires running a length of said data transfer cable;
iv. an insulating sheath disposed at one of said data transfer cable first or second ends, said insulating sheath surrounding said data transmission wires and having,
(1) a first end,
(2) a second end opposite said sheath first end and connected to either of said data transfer cable first or second ends,
(3) at least one side surface extending between said insulating sheath first and second ends, and
(4) a tab extending outwardly from said insulating sheath side surface, said tab defining a through-hole;
v. a connector, said connector slidably engaging said insulating sheath tab through-hole; and
vi. a plug extending outwardly from said insulating sheath first end, said plug further comprising a plurality of data transfer pins where at said plurality of data transmission wires terminate; and
b. an electronic data receiving component comprising a jack, said jack comprising a plug receiving recess with a plurality of data transfer pins;
wherein said plug data transfer pins align with said jack data transfer pins and said connector is releasably attached to the electronic data receiving component when the electronic data transfer cable is in engagement with the electronic data receiving component.

15. The electronic data transfer system of claim 14, wherein the plug is a Universal Serial Bus A plug.

16. The electronic data transfer system of claim 14, wherein the plug is a Universal Serial Bus B plug.

17. The electronic data transfer system of claim 14, wherein the tab of the insulating sheath is positioned above said plug.

18. The electronic data transfer system of claim 14, wherein said insulating sheath further comprises a flexible stopping-tab located on said side surface intermediate said tab and said through-hole.

19. The electronic data transfer system of claim 14, wherein said connector is a threaded thumb screw comprising a head, a shaft, and a plurality of screw threads formed on said shaft.

20. The electronic data transfer system of claim 19, wherein said insulating sheath tab through-hole further comprises a circumferential rib located within said through-hole.
